(19) United States
(12) Patent Application Publication
(10) Pub. No.: US 2002/0103707 A1
(43) Pub. Date: Aug. 1, 2002

(54) Data processing method, data processing apparatus and portable electronic terminal

(75) Inventors: Masanori Takeuchi, Tagata-gun (JP); Yoshiaki Gomi, Sunto-gun (JP); Masaaki Makino, Numazu-shi (JP)

Correspondence Address: OBLON SPIVAK MCCLELLAND MAIER & NEUSTADT PC, FOURTH FLOOR, 1755 JEFFERSON DAVIS HIGHWAY, ARLINGTON, VA, 22202, US

(73) Assignee: Toshiba TEC Kabushiki Kaisha, Tokyo (JP)

(21) Appl. No.: 10/057,927

(22) Filed: Jan. 29, 2002

(30) Foreign Application Priority Data
Jan. 30, 2001 (JP) 2001-021519

(51) Int. Cl. G06F 17/60

(52) U.S. Cl. 705/16

(57) ABSTRACT

This invention permits the customer information used for a ticketing operation to be acquired from the owner information stored in an owner information file of a portable electronic terminal, thus leading to utilization of the owner information such as addresses, etc. stored in the owner information file for a ticketing operation as the customer information. Thereby, a manual input of addresses, etc., in a product sales data processing apparatus can be saved. Accordingly, a store with installation of the product sales data processing apparatus will achieve shortening of operation time, improvement of work efficiency, and reduction of mistakes, and a customer who owns the portable electronic terminal will be able to enjoy enhancement of the convenience and serviceability.

### CROSS REFERENCE TO RELATED APPLICATION

The present application is based on Japanese Priority Document 2001-021519 filed on Jan. 30, 2001, time content of which is incorporated herein by reference.

### BACKGROUND OF INVENTION

1. Field of the Invention

The present invention relates to a data processing method, a data processing apparatus and a portable electronic terminal, especially relates to a ticketing method as the data processing method that are employed in stores, such as convenience stores, consigned for ticketing business from a ticket company and a sales data processing apparatus and portable electronic terminal used for the ticketing method of the present invention.

2. Discussion of the Background

Chain stores that practice sales business, expanding stores in various places, make good use of the POS (Point of Sales) apparatus, and thereby collectively grasp the sales situations of each of the stores to make up the total sales strategies.

Here, the POS system as mentioned above includes, for example, multiple POS terminals that execute processing of various data, one store computer established in each of multiple stores that executes processing of the various data received from the multiple POS terminals, and a host computer established in the headquarters that executes processing of various data by receiving the various data from the store computers established in each of the multiple stores.

Now, the POS terminal of each store registers product sales data, etc., stores them sequentially, and sends the transaction data generated from the stored various data to the store computer of the same store after completing the registration processing. Then, the store computer of each store totalizes the transaction data received from the POS terminals of the same store, and sends the totalized transaction data to the host computer of the headquarters, at a predetermined regulated timing, for example, once a day.

By utilizing the POS system as such, each store is able to confirm the sales situation, and the headquarters is able to confirm collectively the sales situations of the multiple stores.

Incidentally, in the convenience stores, etc., provided with this type of POS system, recently some stores practice the sales by reservation of various tickets, such as concert tickets as one of the services. In such stores, ticket printers exclusive for ticketing are connected to the POS terminals, and the ticket printers print the tickets exclusively.

However, with the existing apparatus, a subscriber has to fill up an application form with his/her name, address, etc. when reserving a ticket, thus making the procedure troublesome.

On the other hand, a store clerk has to manually input the name, address, etc., written in the application form to the POS terminal. Such operation is a comparably time consuming work for convenience stores, and can easily become an obstacle to other operations (especially, sales settlement operation, etc).

### SUMMARY OF THE INVENTION

The present invention has been made in view of these circumstances, and it is an object of the invention to achieve shortening of operation time, enhancement of work efficiency, and reduction of mistakes for the stores with provision of the sales data processing apparatus, and to improve serviceability for the customers.

The object of the present invention is achieved by the novel data processing method, a data processing apparatus and a portable electronic terminal of the present invention.

According to a data processing method of the present invention, comprising the steps of:

executing a data communication by establishing an access between a data processing apparatus executing data processing with respect to an objective action and a portable electronic terminal storing necessary data for the data processing;

transmitting the data from the portable electronic terminal to the data processing apparatus when the data processing for the objective action is executed while the access between the data processing apparatus and the portable electronic terminal is established,

the data processing apparatus receiving the data from the portable electronic terminal when the data processing for the objective action is executed while the access between the data processing apparatus and the portable electronic terminal is established; and

the data processing apparatus executing the data processing with respect to the objective action by using the received data.

According to a data processing apparatus of the present invention, comprising:

means for executing a data communication by establishing an access from a portable electronic terminal storing necessary data for data processing with respect to an objective action;

means for receiving the data from the portable electronic terminal through the means for executing the data communication when the data processing for the objective action is executed; and

means for executing the data processing with respect to the objective action by using the received data.

According to a portable electronic terminal of the present invention, comprising:

means for executing a data communication by establishing an access from a data processing apparatus executing data processing with respect to an objective a data file storing necessary data for the data processing with respect to the objective action; and

means for transmitting the data through the means for executing the data communication when the data processing for the objective action is executed.

### BRIEF DESCRIPTION OF THE DRAWINGS

A more complete appreciation of the present invention and many of the attendant advantages thereof will be readily obtained as the same becomes better understood by reference to the following detailed description when considered in connection with the accompanying drawings, wherein:

FIG. 1 is a schematic view, illustrating the POS system provided with POS terminals configuring the ticketing system relating to the embodiment of the invention;

FIG. 2 is an external perspective view of the POS terminal;

FIG. 3 is a block diagram illustrating the electrical connections between the units built in the POS terminal;

FIG. 4 is a block diagram illustrating the electrical connections between the units built in a cellular phone;

FIG. 5 is a schematic flow chart illustrating the ticketing processing;

FIG. 6 is an explanatory chart illustrating a data communication between the POS terminal and the cellular phone;

FIG. 7(A) is a front view illustrating a state that a request to send customer data screen is displayed, as an example of a screen presented on a display of the cellular phone;

FIG. 7(B) is a front view illustrating a state that a customer data confirmation screen is displayed, as an example of a screen presented on a display of the cellular phone;

FIG. 7(C) is a front view illustrating a state that a customer data sending screen is displayed, as an example of a screen presented on a display of the cellular phone; and

FIG. 8 is a front view of the ticket that is printed out from a ticket printer.

### DETAILED DESCRIPTION OF THE PREFERRED EMBODIMENT

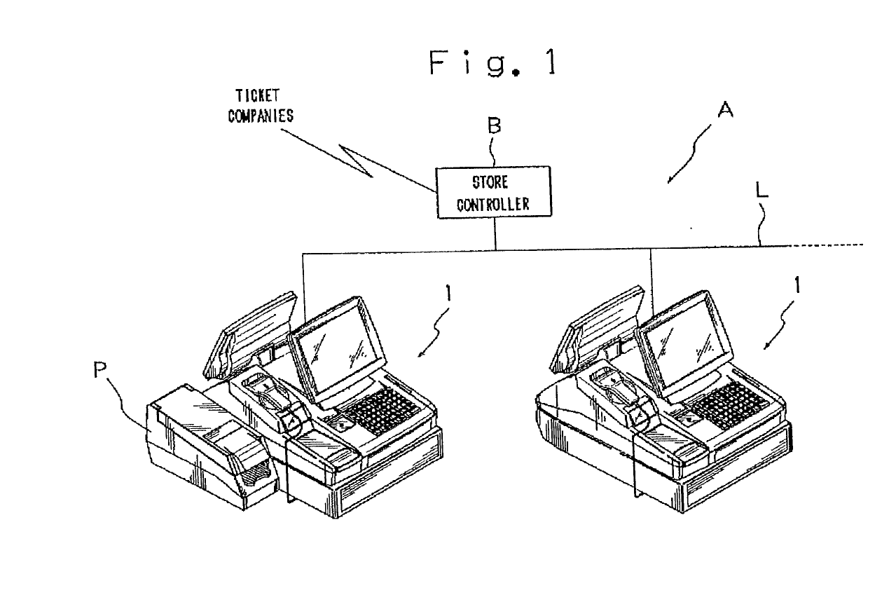

The embodiment according to the present invention will be explained based on FIG. 1 through FIG. 8.

The ticketing system of the embodiment comprises a sales data processing apparatus as a data processing apparatus and a cellular phone as a portable electronic terminal. The ticketing system of the embodiment executes a data processing method of the present invention. Accordingly, the sales data processing apparatus operates as the data processing apparatus for executing data processing with respect to an objective action as ticket printing. The cellular phone as the portable electronic terminal stores necessary data for data processing with respect to the objective action as described following.

This embodiment will describes one example that applies the POS (Point of Sale) terminals used in stores such as convenience stores consigned for the ticketing operation of concert tickets, air tickets, travel tickets, etc., by a ticket company to the sales data processing apparatus.

FIG. 1 illustrates a schematic drawing of a POS system A comprising POS terminals 1 that constitute the ticketing system of the embodiment. The POS system A comprises a store controller B, established in the back yard of a convenience store, plural POS terminals 1, established on cash registers of the same, and a ticket printer P for printing tickets connected to a specific POS terminal 1. The store controller B and the plural POS terminals 1 are connected to each other through a LAN (Local Area Network) cable L.

Since the technology is well known, a detailed explanation will be omitted except for the fact that the store controller B manages sales data from each POS terminal 1. Also, the store controller B is connected to a host computer of the headquarters, and the host computer of the headquarters manages data transmission to/from ticket companies, etc.

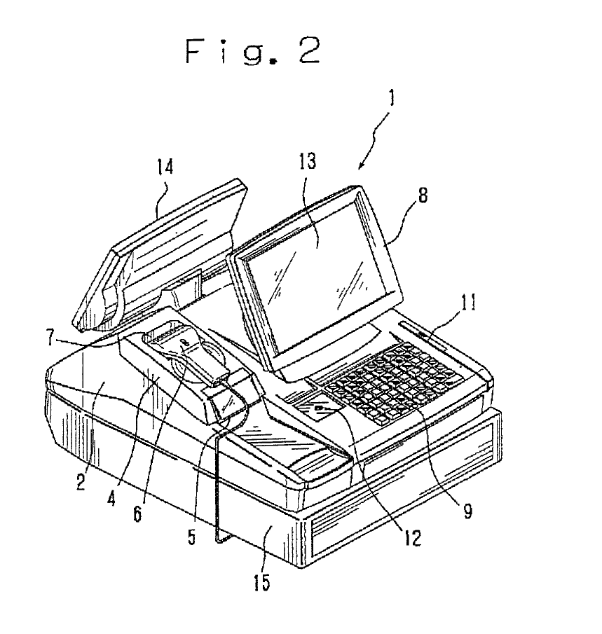

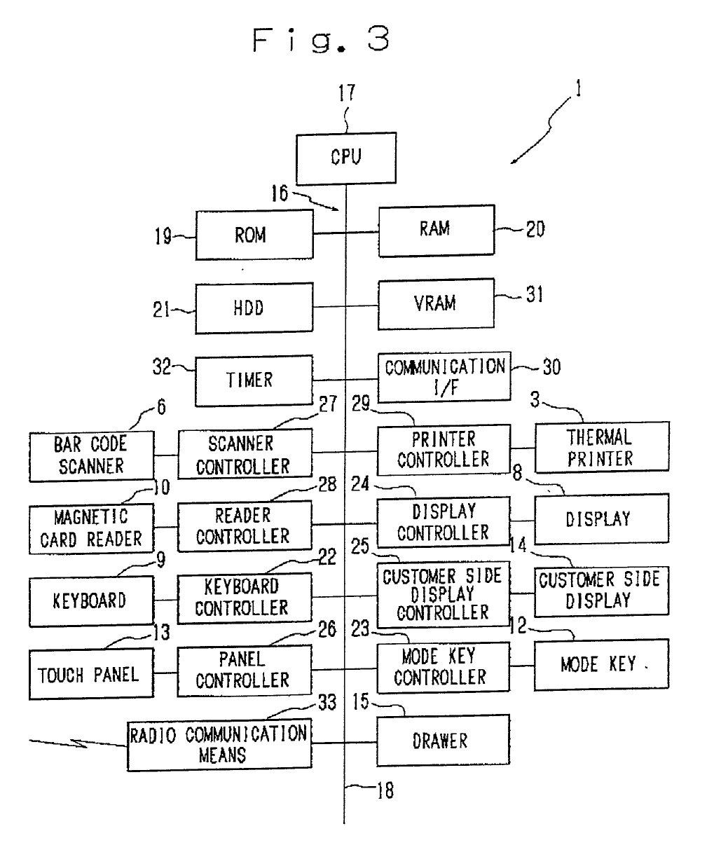

Now, FIG. 2 illustrates a schematic perspective of the POS terminal 1. As shown in FIG. 2, on the left side viewed from an operator of the POS terminal 1 enclosed in a body case 2, a thermal printer 3 (refer to FIG. 3) is provided, which is housed inside a printer cover 4. Further, on the printer cover 4, a receipt aperture 5 is formed, from which receipts (not illustrated) printed by the thermal printer 3 are discharged. Also, on the upper part of the printer cover 4, a bar code scanner 6 is mounted on a concave-formed scanner-placing unit 7, which optically reads product codes attached to the products. On the other hand, on the right side viewed from the operator of the POS terminal 1 are established a freely tiltable display 8 being an LCD (Liquid Crystal Display) that functions as a display device, a keyboard 9 on which various keys are assembled, a magnetic card insertion aperture 11 for inserting magnetic cards into a magnetic card reader 10 (refer to FIG. 3), and a mode key 12 that is operated and switched by a key not illustrated, etc.

Also, the display 8 has a touch panel 13 furnished thereon. The display 8 will exhibit the same function as the keyboard, by synchronizing the positional relation between the buttons, etc. displayed on the display 8 and the positional coordinates of the touch panel 13.

In addition, a customer side display 14 is provided on the back of the POS terminal 1, facing to a customer. The POS terminal 1 as such is mounted on a drawer 15 for use.

Next, the electric connection of the units built in the POS terminal 1 thus configured will be explained with reference to FIG. 3. As shown in FIG. 3, the POS terminal 1 incorporates a microcomputer 16, and the microcomputer 16 drives and controls each of the units. The microcomputer 16 includes a CPU (Central Processing Unit) 17 that controls each of the units intensively, to which are connected via a bus line 18 including address buses, data buses, etc., a ROM (Read Only Memory) 19 that stores fixed data such as startup programs in advance, a RAM (Random Access Memory) 20 that configures various buffers, such as sales buffer, print buffer, etc., and stores various data rewritably, and a timer 32 that clocks date and time. In addition, a VRAM (Video Random Access Memory) 31 which develops display data, etc. with high speed is connected to the bus line 18.

Also, to the bus line 18 connected to the CPU 17 is connected a HDD (Hard Disk Drive) 21 which is a storage medium; and, the HDD 21 stores a control program for operating the microcomputer 16, and other various data files. The various data files include, for example, a product master file, a sales master file, etc. Though not specifically illustrated, the product master file is provided with a file structure that stores and retains product names, unit prices, section codes, etc., in association with each of the product codes. The sales file is provided with a file structure that stores and retains the sales history of products such as sales details and sales amounts.

The control program stored in the HDD 21 is written into the RAM 20 at start-up time of the POS terminal 1, along with the product master file, etc., thus enabling the microcomputer 16 to drive and control each of the units. Next, the units to be driven and controlled by the microcomputer 16 will be explained.

The keyboard 9 is connected to the bus line 18 via a keyboard controller 22, and inputs signals corresponding to operated keys to the microcomputer 16 through the operation of the keyboard controller 22.

The mode key 12 is connected to the bus line 18 via a mode key controller 23, and inputs signals corresponding to switched positions to the microcomputer 16 through the operation of the mode key controller 23. The microcomputer 16 sets the operation mode of the POS terminal 1 to each operation mode such as registration mode, setting mode, adjustment made, and inspection mode, in accordance with an output signal from the mode key 12.

The display 8 is connected to the bus line 18 via a display controller 24, and when a display data is inputted to the display controller 24 from the microcomputer 16, the display 8, driven by the display controller 24, displays the specified items.

The customer side display 14 is connected to the bus line 18 via a customer side display controller 25, and when a customer side display data is inputted to the customer side display controller 25 from the microcomputer 16, the customer side display 14, driven by the customer side display controller 25, displays the specified items.

The touch panel 13 is connected to the bus line 18 via a panel controller 26, and through the operation of the panel controller 26, the touch panel 13 acquires a coordinate data in terms of the XY coordinate by recognizing a position on the panel touched by an operator, and outputs to the microcomputer 16 a signal corresponding to the acquired coordinate data. When the signal is inputted to the microcomputer 16, the microcomputer 16 executes a specified processing based on this signal.

The bar code scanner 6 is connected to the bus line 18 via a scanner controller 27, and transmits the read product code data to the microcomputer 16 through the operation of the scanner controller 27.

The magnetic card reader 10 is connected to the bus line 18 via a reader controller 28, and outputs information stored on a magnetic card to the microcomputer 16 through the operation of the reader controller 28.

Also, the thermal printer 3 built in the POS terminal 1 is connected to the bus line 18 via a printer controller 29, and is driven and controlled by the microcomputer 16. Further, this thermal printer 3 has a cutter unit (not illustrated) built in, which is driven and controlled by the microcomputer 16. Thereby, the thermal printer 3 displays a function as a receipt printer, by printing out necessary items for a receipt on a long piece of receipt paper not illustrated, cutting and discharging the receipt from the receipt aperture 5.

Further, in the POS terminal 1, a plurality of communication I/Fs 30 that send and receive data by connecting the other POS terminals 1 and the store controller B, etc., via the LAN cable L are connected to the bus line 18, and are driven and controlled by the microcomputer 16. Also, the communication I/F 30 of a specific POS terminal 1 is connected to the ticket printer P, which permits the ticket printer P to print a ticket printing data outputted from the POS terminal 1 as a ticket.

The drawer unit 15 established separately from the POS terminal 1 is also driven and controlled by the microcomputer 16.

In addition, the POS terminal 1 is furnished with a radio communication means 33, which is connected to the bus line 18, and is driven and controlled by the microcomputer 16. This radio communication means 33 is, for example, the Bluetooth. The POS terminal 1 is able to send and receive data and programs to/from the other devices incorporating the Bluetooth, by the control or the microcomputer 16. Here, an access between the devices incorporating the Bluetooth being established, a data communication means for executing data communication is implemented.

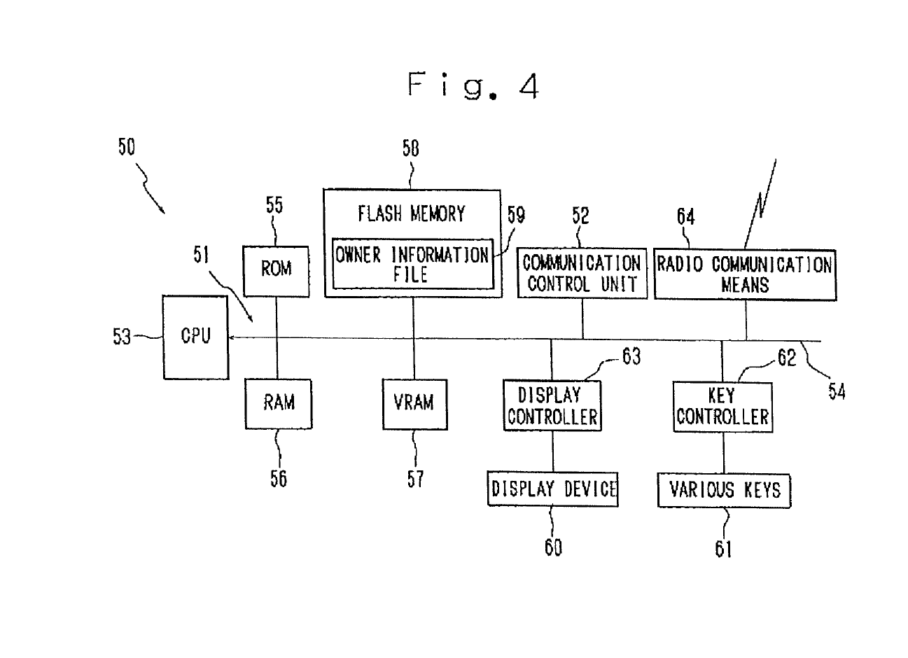

Next, a cellular phone 50 will be explained with reference to FIG. 4, which configures the ticketing system of this embodiment along with the POS system A. With regard to the appearance, etc., of the cellular phone 50 relating to the embodiment, there is not any difference at all from the well-known, therefore the explanation thereof will be omitted. As shown in FIG. 4, the cellular phone 50 is provided with microcomputer 51, and the microcomputer 51 drives and controls each of the units such as a communication control unit 52, a display device 60, various keys 61, etc., which displays a telephone function. The microcomputer 51 includes a CPU 53 that controls each of the units intensively, to which are connected via a bus line 54 a ROM 55 that beforehand stores fixed data such as a control program to operate the microcomputer 51, and a RAM 56 that stores various data rewritably to function as a work area. In addition, the bus line 54 is connected to a VRAM (Video Random Access Memory) 57 which develops display data, etc. with high speed, and to a nonvolatile flash memory 58. The flash memory 58 holds an owner information file (data file) 59, which writes owner information (name, address, phone number, etc.) for identifying owner as the data for data processing with respect to the objective action as ticket printing.

The control program stored in the ROM 55 is written into the RAM 56 at the startup time of the cellular phone 50, whereby the microcomputer 51 becomes able to drive and control each of the units. The units driven and controlled by the microcomputer 51 will be explained hereunder.

The various keys 61 is connected to the bus line 54 via a key controller 62, and inputs a signal corresponding to each operated key 61, through the operation of the key controller 62.

The display device 60 is connected to the bus line 54 via a display controller 63, and when a display data from the microcomputer 51 is inputted to the display controller 63, the display device 60, driven by the display controller 63, displays an image based on the display data.

Also, the cellular phone 50 is provided with a radio communication means 64. The radio communication means 64 is connected to the bus line 54 and is driven and controlled by the microcomputer 51. This radio communication means 64 is, for example, the Bluetooth. The cellular phone 50 is able to send and receive data and programs to/from the other devices incorporating the Bluetooth, by the control of the microcomputer 51. Here, an access between the devices incorporating the Bluetooth being established, a data communication means or a data communication step for executing data communication is implemented.

Now, in the POS terminal 1 relating to the embodiment, when one access from one cellular phone 50 is established, the other accesses from the other cellular phones 50 are excluded. This is to prevent an incorrect data from being sent to the POS terminal 1, by establishing one-to-one data communication between the cellular phone 50 and the POS terminal 1. Further, in the POS terminal 1 relating to the embodiment, the accesses from the cellular phones 50 are limited to a given business menu operation time. This is to prevent fraudulent accesses from the cellular phones 50 to POS terminal 1.

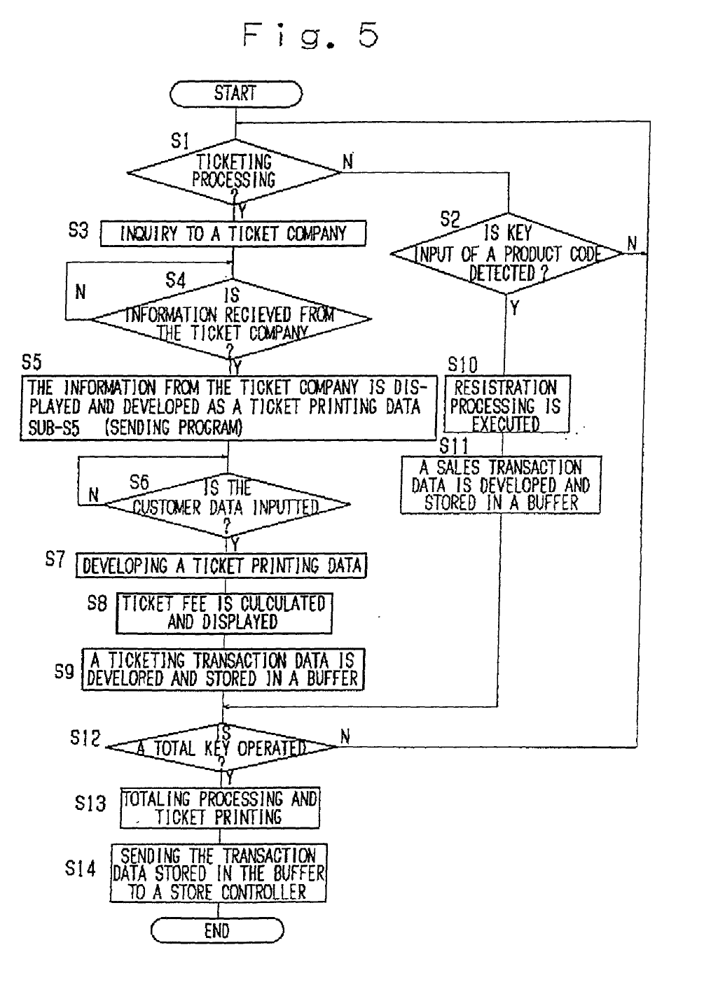

In this configuration, of the functions that the ticketing system relating to the embodiment exhibits, distinctive functions will be explained hereunder. Here, on the premise that the registration mode is set by the switching operation of the mode key 12 of the POS terminal 1, the ticketing process executed by the microcomputer 16 of the POS terminal 1 will be explained with reference to FIG. 5.

As shown in FIG. 5, the microcomputer 16 of the POS terminal 1 executes a ticketing processing when it detects a key input by a ticketing key (not illustrated) on the keyboard 9 during the registration processing (Y at step S1). When it detects a key put of a product code from the keyboard 9 or the bar code scanner 6 (Y at step S2), it will execute the registration processing of the sales data of the product.

Next, the processing in the case where the key input from the ticketing key (Y at step S1) is detected will be explained. Here, when the key input from the ticketing key (Y at step S1) is detected, the display 8 of the POS terminal 1 displays a ticketing screen (not illustrated).

Then, a confirmation task for a requested ticket will be performed through the inquiry to the ticket company (step S3).

As a result, if the ticket is confirmed, information concerning seat numbers, etc. is sent online from the ticket company to the POS terminal 1 (Y at step S4). Then, the information is displayed on the ticketing screen of the display 8 of the POS terminal 1, and is developed as a ticket printing data in the specified area of the RAM 20 (step S5).

Next, proceeding to step 6, the microcomputer 16 waits for the input of customer data that are personal information, such as name, address, phone number, etc. of the ticket purchaser. The input of the customer data can be done in a traditional manner from the keyboard 9 or the touch panel 13. However, the ticketing system relating to the embodiment makes the input executable by the radio communication between the POS terminal 1 and the cellular phone 50.

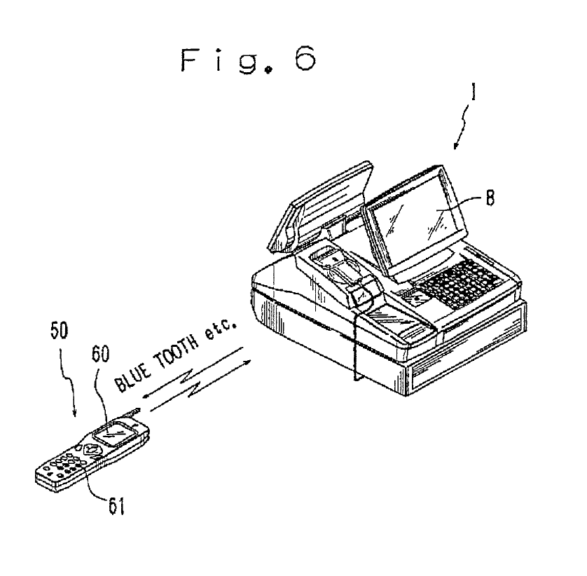

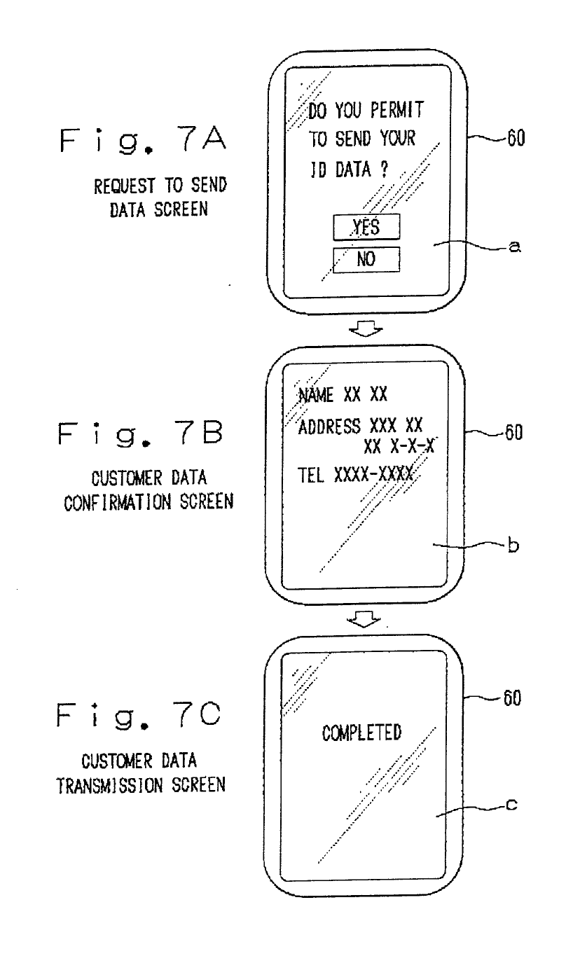

As shown in FIG. 6, the POS terminal 1 and the cellular phone 50 are able to send and receive data or programs through the radio communication of the radio communication means 33 and the radio communication means 64 that use the Bluetooth, for example. To be more precise, after the POS terminal 1 determines the cellular phone 50 owned by the ticket purchaser, it sends a program (for example, JAVA applet, etc.) to the concerned cellular phone 50, and displays a request to send customer data screen (request to send data screen) a on the display device 60 of the cellular phone 50 as illustrated in FIG. 7(A) (sub-step S5). Here, a program transmission means or a program transmission step is executed. The request to send customer data screen a is for selecting whether to or not to authorize the transmission of the customer data.

As described above, when a ticket purchaser operates the cellular phone 50 on which the request to send customer data screen a is displayed on the display device 60, and the transmission of the customer data is authorized, a customer data confirmation screen b shown in FIG. 7(B) is displayed on the display device 60 of the cellular phone 50. On the customer data confirmation screen b, the customer data (address, name, phone number, etc.) that are personal information of the ticket purchaser are displayed. Here, the customer data displayed on the customer data confirmation screen b is stored in the owner information file 59. In other words, the ticket purchaser will be transmitting the customer data to the POS terminal 1 by means of the radio communication, through the operation of the cellular phone 50 with the request to send customer data screen a displayed on display device 60.

Further, when the customer data (address, name, phone number, etc.) is confirmed, it is transmitted to the POS terminal 1 from the cellular phone 50 through a key operation on the keys 61 of the cellular phone 50 by the ticket purchaser. After completion of the transmission, a customer data transmission screen c shown in FIG. 7(C) is displayed on the display device 60 of the cellular phone 50. Here, the function of data transmission means or data transmission step is executed on the cellular phone 50. With the processing mentioned above, the transmission of the customer data to the POS terminal 1 from the cellular phone 50 is completed.

When the customer data is inputted (Y at step S6: data receiving means or data receiving step), it is developed in a specified area in the RAM 20 as a ticket printing data (step 7).

Next, proceeding to step 8, the fee is calculated and displayed on the display 8, and on the customer side display 14.

Then, the microcomputer 16 of the POS terminal 1 generates a ticketing transaction data on the basis of the data having the ticketing processing completed as mentioned above, and temporarily stores the data in a buffer of the RAM 20 (step 9).

On the other hand, when a key input of a product code through the operation of the keyboard 9 or the bar code scanner 6 (Y at step S2) is detected, the unit price is read from the product master file in the RAM 20 based on the inputted product code, and the number of sales and amount of sales are stored accumulatively for each product code. Then, a registration processing, such as adding sales amount to the sales buffer in the RAM 20, is executed (step S10).

Next, the microcomputer 16 of the POS terminal 1 generates a transaction data with the sales data of the registration processed products, and stores the transaction data in a buffer of the RAM 20 (step 11).

Then, if the total key (not illustrated) on the keyboard 9 is operated (Y at step S12), the microcomputer 16 of the POS terminal 1 will execute the totaling processing of the ticketing data and product sales data having the registration processing repeated as desired.

Next, in the totaling processing or step 13, the total amount is calculated, which is displayed on the display 8 and on the customer side display 14, and, for example, a change is calculated, the drawer 15 is opened, and the thermal printer 3 prints various information on the receipt. Here, the function of objective execution means or objective execution step is executed on the POS terminal 1.

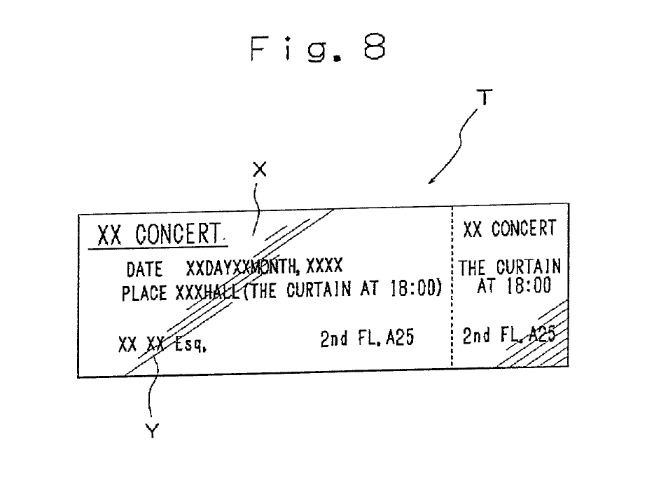

Also, in the ticketing processing of a ticket, the ticket printing data developed in a specified area in the RAM 20 is outputted to the ticket printer P from the POS terminal 1, and the ticket is printed out based on this ticket printing data. Here, FIG. 8 illustrates a front view of a ticket T printed by the ticket printer P. As shown in FIG. 8, the outputted ticket T has information X suuh as title, date, seat number, etc. along with a customer data (name of the ticket purchaser) Y printed on it.

Completing the registration processing as described above, the microcomputer 16 sends the transaction data composed of the product sales data stored in the buffer of the RAM 20 and the transaction data composed of the ticketing data, to the store controller B through the communication I/F 30 (step S14).

Further, having received the transaction data, the store controller B determines whether the transaction data is a product sales data or a ticketing data by the identification code and the like. Then, the store controller B temporarily stores the transaction data composed of the product sales data in the RAM, etc., and transfers the transaction data composed of the ticketing data immediately to the host computer. Also, having received the transaction data composed of the ticketing data, the host computer immediately transfers the transaction data composed of the ticketing data to a host computer of the ticket company.

Here, sending a program for displaying the request to send data screen a to the cellular phone 50, the POS terminal 1 makes the cellular phone 50 display the request to send data screen a for authorizing the transmission of the owner information stored in the owner information file 59, thus allowing the owner to authorize the transmission of the owner Information while referring to the request to send data screen a. On the other hand, the cellular phone 50 displays the request to send data screen a in accordance with the program sent from the POS terminal 1, and makes the owner authorize the transmission of the owner information stored in the owner information file 59, whereby the owner information of which transmission has been authorized by the cellular phone 50 becomes possible to be sent to the POS terminal 1. Thus, the POS terminal 1 is able to receive the owner information sent from the cellular phone 50. Thereby, it becomes possible to utilize the owner information such as addresses, etc. stored in the owner information file 59 as the customer information used for the ticketing business. Accordingly, it becomes possible to save the manual input of addresses, etc., at the POS terminal 1, by acquiring the customer information needed for the ticketing operation from the owner information stored in the owner information file 59 of the cellular phone 50, thus shortening the operation time, improving the work efficiency, reducing mistakes in the stores with the POS terminals 1, and improving the convenience and serviceability for the owners of cellular phones 50.

Further, in the embodiment, the ticketing operation processing has been used as an example for the explanation, but it is not limited to this. For example, it is also possible to acquire the names of clients in the reception operation of a home delivery service, from the owner information stored in the owner information file 59 of the cellular phone 50.

Also, in the embodiment, the cellular phone 50 is adopted as a portable electronic terminal, but it is not limited to this, and the so-called portable information terminal such as a PC notebook, PDA (Personal Digital Assistants), PHS (Personal Handy-phone System) can also be adopted.

According to the invention, it is possible to make a portable electronic terminal display the request to send data screen for giving the authorization to transmit data stored in a data file, thus allowing the owner to refer to the request to send data screen and authorize the transmission of the data. On the other hand, when the data authorized as to the transmission in accordance with the request to send data screen is sent from the portable electronic terminal, the reception of the data by the product sales data processing apparatus makes it possible to save the manual input to this product sales data processing apparatus, concerning the data stored in the data file of the portable electronic terminal. Thereby, the stores with installation of the product sales data processing apparatus are able to shorten the operation time, to improve the work efficiency, and to reduce mistakes, and the customers who own the portable electronic terminals are able to enjoy enhanced convenience and serviceability.

Also, while the data communication means has been establishing the access from one of the portable electronic terminals, the accesses from the other portable electronic terminals are excluded and not to be established, accordingly the portable electronic terminal and the product sales data processing apparatus are able to execute the communications of data in one-to-one relation, whereby the transmission of false data can be prevented to the product sales data processing apparatus.

Furthermore, limiting the accesses from the portable electronic terminals to a predetermined business menu operation time will make it possible to prevent a fraudulent access from a portable electronic terminal to the product sales data processing apparatus.

Obviously, numerous modifications and variations of the present invention are possible in light of the above teachings. It is therefore to be understood that within the scope of the appended claims, the invention may be practiced otherwise than as specifically described herein.

What is claimed is:

1. A data processing method, comprising:
data communication step for executing a data communication by establishing an access between a data processing apparatus executing data processing with respect to an objective action and a portable electronic terminal storing necessary data for the data processing;
data transmission step for transmitting the data from the portable electronic terminal to the data processing apparatus when the data processing for the objective action is executed while the access between the data processing apparatus and the portable electronic terminal is established,
data reception step for the data processing apparatus receiving the data from the portable electronic terminal when the data processing for the objective action is executed while the access between the data processing apparatus and the portable electronic terminal is established; and
objective execution step for the data processing apparatus executing the data processing with respect to the objective action by using the received data.

2. A data processing method according to claim 7, wherein the processing apparatus processes product sales data.

3. A data processing method according to claim 2, wherein the data communication step allows the portable electronic terminal to access to the data processing apparatus while the processing apparatus is set so as to operate predetermined business menu.

4. A data processing method according to claim 2, wherein the objective action is ticket printing, and the data processing for the objective action is data processing for ticket printing.

5. A data processing method according to claim 4, wherein the data for data processing with respect to the objective action is data for identifying a person who purchases the ticket.

6. A data processing method according to claim 1, the data for data processing with respect to the objective action is stored in a data file of the portable electronic terminal.

7. A data processing method according to claim 1, wherein when an access from one of the portable electronic terminals is established, the data communication step excludes the accesses from the other portable electronic terminals.

8. A data processing method according to claim 1, 2, 3, 4, 5, 6 or 7, further comprising program transmission step for the data processing apparatus transmitting a program, which allows the portable electronic terminal to send the data for data processing with respect to the objective action to the data processing apparatus, to the portable electronic terminal so as to be installed into thereof, when the data processing for the objective action is executed while the access between the data processing apparatus and the portable electronic terminal is established,
wherein the data transmission step, comprising:
first sub-step for the portable electronic terminal receiving the program from the data processing apparatus; and
second sub-step for transmitting the data from the portable electronic terminal to the data processing apparatus according to the program.

9. A data processing method according to claim 8, wherein
the program transmission step transmits the program which presents performance to the portable electronic terminal being able to display a request to send data screen for permitting the portable electronic terminal to send the data for data processing with respect to the objective action, and being able to send the data to the data processing apparatus when the data sending is permitted on the request to send data screen,
the second sub-step allows the portable electronic terminal to display the request to send data screen and transmits the data to the data processing apparatus when the data sending is permitted on the request to send data screen, according to the program.

10. A data processing apparatus, comprising:
data communication means for executing a data communication by establishing an access from a portable electronic terminal storing necessary data for data processing with respect to an objective action;
data reception means for receiving the data from the portable electronic terminal through the data communication means when the data processing for the objective action is executed, and
objective execution means for executing the data processing with respect to the objective action by using the data received by the data reception means.

11. A data processing apparatus according to claim 10, wherein the processing apparatus is a product sales data processing apparatus for processing product sales data.

12. A data processing apparatus according to claim 11, wherein the data communication means allows the portable electronic terminal to access to the data processing apparatus while the processing apparatus is set so as to operate predetermined business menu.

13. A data processing apparatus according to claim 11, wherein the objective action is ticket printing, and the data processing for the objective action is data processing for ticket printing.

14. A data processing apparatus according to claim 13, further comprising a ticket printer for printing a ticket according to the data processing for ticket printing.

15. A data processing apparatus according to claim 11, wherein the data for data processing with respect to the objective action is data for identifying a person who purchases the ticket.

16. A data processing apparatus according to claim 11, wherein when an access from one of the portable electronic terminals is established by the data communication means, the data communication means excludes the accesses from the other portable electronic terminals.

17. A data processing apparatus according to claim 10, 11, 12, 13, 14, 15 or 16, further comprising program transmission means for transmitting a program, which allows the portable electronic terminal to send the data for data processing with respect to the objective action to the data processing apparatus, to the portable electronic terminal so as to be installed into thereof, when the data processing for the objective action is executed.

18. A data processing apparatus according to claim 17, wherein the program presents performance to the portable electronic terminal being able to display a request to send data screen for permitting the portable electronic terminal to send the data for data processing with respect to the objective action, and being able to send the data to the data processing apparatus when the data sending is permitted on the request to send data screen.

19. A portable electronic terminal, comprising:
data communication means for executing a data communication by establishing an access from a data processing apparatus executing data processing with respect to an objective action;
a data file storing necessary data for the data processing with respect to the objective action; and
data transmission means for transmitting the data through the data communication means when the data processing for the objective action is executed.

20. A portable electronic terminal according to claim 19, wherein the data transmission means, comprising:
first means for receiving a program, form the data processing apparatus, which allows the portable electronic terminal to send the data for data processing with respect to the objective action to the data processing apparatus; and
second means for transmitting the data to the data processing apparatus according to the program.

21. A portable electronic terminal according to claim 19, wherein
the first means receives the program which presents performance being able to display a request to send data screen for permitting the portable electronic terminal to send the data for data processing with respect to the objective actions and being able to send the data to the data processing apparatus when the data sending is permitted on the request to send data screen,
the second means displays the request to send data screen and transmits the data to the data processing apparatus when the data sending is permitted on the request to send data screen, according to the program.
